(19) United States
(12) Patent Application Publication
(10) Pub. No.: US 2009/0287636 A1
(43) Pub. Date: Nov. 19, 2009

(54) User removable memory and associated methods

(75) Inventors: Yong Ren, Beijing (CN); Xin Zhang, Beijing (CN); Can Feng Chen, Beijing (CN); Jian Ma, Beijing (CN)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 12/154,143

(22) Filed: May 19, 2008

(51) Int. Cl. G06F 17/30; G06F 12/00

(52) U.S. Cl. 707/1; 711/115; 707/200; 711/E12.001; 707/E17.01

(57) ABSTRACT

Apparatus for user removable memory, the memory for providing functional expansion to an associated electronic device, the apparatus comprising an interface configured for converting signalling between file access signalling for an associated electronic device and appropriate signalling for the use by the memory in providing the functional expansion.

### TECHNICAL FIELD

The present invention relates to apparatus for user removable memory, the memory for use in the functional expansion of an associated electronic device. The invention also relates to associated methods, computer program products, circuitry/hardware comprising computer programs, user removable memory (e.g. memory cards) per se (including SD—Secure Digital—memory cards).

The memory is for use with electronic devices. In certain circumstances, these electronic devices may be portable electronic devices, which may or may not be hand-held in use (although they may be placed in a cradle in use). Such hand-portable electronic devices include so-called Personal Digital Assistants (PDAs).

Such portable electronic devices may provide one or more audio/text/video communication functions (e.g. telecommunication, videocommunication, and/or text transmission (Short Message Service (SMS)/Multimedia Message Service (MMS)/emailing) functions), interactive/non-interactive viewing functions (e.g. web-browsing, TV/program viewing functions), music recording/playing functions (e.g. MP3 or other format and/or (FM/AM) radio broadcast recording/playing), downloading/sending of data functions, image capture function (e.g. using a (e.g. in-built) digital camera), and gaming functions.

The electronic devices need not be portable and can include televisions, desktop computers or other user operable electronic devices providing audio/visual content to a user.

### BACKGROUND OF THE INVENTION

Portable devices often include an expansion card slot, in order to allow users to expand storage capacity or other specific functions for the portable devices. With the development of technology, which is often driven by user requirements, there is an increasing requirement to expand hardware functions.

Secure Digital Input Output (SDIO) is one case of such kind of special purpose expansion hardware. The following functions have been already implemented using SDIO: wireless network interface card, Bluetooth adapter, GPS (global positioning system) receiver, digital TV receiver, etc. There are some other types of expansion hardware with similar purpose, such as Multi-Media Card (MMC), Compact Flash (CF) memory cards, PCMCIA (Personal Computer Memory Card International Association) boards/cards, etc.

Though expansion of hardware (such as by using a SDIO expansion card) is possible, there is a compatibility problem for usage on multiple platforms, i.e. it is not easy to use the expansion hardware across different Operating Systems (OS), different CPUs or different host controllers. The current situation is that, it is very difficult to design general purpose SDIO expansion card. Thus, one type of SDIO expansion card can only support one type of (or one series of) digital products.

Compared with desktop digital products, there are heterogeneous types of CPU architecture, host controllers, and OS used for portable devices (referred to as “platform heterogeneity” hereafter). Platform heterogeneity leads to great difficulty for general methods for expanding hardware on portable devices, because different drivers have to be made for different host controllers, CPU and OS. Furthermore, specific driver programs have to be installed (via PC) before using the expansion hardware.

The listing or discussion of a prior-published document in this specification should not necessarily be taken as an acknowledgement that the document is part of the state of the art or is common general knowledge.

### SUMMARY OF THE INVENTION

In a first aspect, there is provided an apparatus for user removable memory, the memory for providing functional expansion to an associated electronic device, the apparatus comprising an interface configured for converting signalling between file access signalling for an associated electronic device and appropriate signalling for the use by the memory in providing the functional expansion.

For example, file access (command) signalling from a PDA to the memory is transformed/translated into a specific format for use by the memory to provide the expanded functionality, and signalling from the memory to the PDA is being transformed/translated into a file (response) access signalling format to provide the expanded functionality i.e. the PDA can just use its file access signalling format and the memory card does the appropriate conversion/translation.

The interface may be configured to convert signalling from within the apparatus, the signalling for the provision of the functional expansion to an associated electronic device, into file access response signalling for an associated electronic device.

The interface may be configured to convert signalling from an associated electronic device from file access command signalling into appropriate signalling, for use within the memory, to provide the functional expansion using the memory.

The interface may be configured to, in response to file access command signalling from an associated electronic device, convert the file access command signalling into appropriate signalling, for use within the memory, for the provision of the functional expansion using the memory, by using file access response signalling.

The interface may be configured to, in response to file access command signalling from an associated electronic device, convert the file access command signalling into appropriate signalling, for use within the memory, for the provision of the functional expansion using the memory and provide, in response to the file access command signalling, file access response signalling from the apparatus to an associated electronic device to provide the functional expansion.

The file access signalling may comprise one or more of read/write request/response signalling.

The apparatus may be configured to force updating of a cache of the associated electronic device with virtualized file(s), the virtualized file(s) for providing for the functional expansion of the associated electronic device, by creating cache-miss events.

The user removable memory may conform to one or more of a SD format, a MMC format, CF format, and a PCMCIA format.

The functional expansion may comprise the provision of wireless functionality. The wireless functionality may comprise one or more of WLAN functionality, Zigbee™ functionality, Wibree™ functionality, Bluetooth T functionality, GPS functionality, digital TV receiver functionality, audio functionality and video functionality.

The wireless functionality may provide for connection of an associated electronic device with a user interface apparatus (e.g. a keyboard or electronic display).

The functional expansion may comprise the provision of functionality not already integrated with or available to an associated electronic device. For example, the electronic device may not be sold with circuitry which provides for wireless connection, and the memory may provide the wireless connection function to the device. In other embodiments, the functional expansion may comprise the provision of functionality already integrated with or available to an associated electronic device. In other embodiments still, some of functional expansion may already be integrated/available and other functional expansion may not already be integrated/available. The functional expansion may work together with some functionality already available (and dormant/disabled) in the device to provide the functional expansion.

The apparatus may comprise a transceiver for providing the functional expansion, and the interface may be configured to convert read/write signalling requests from an associated electronic device into signalling appropriate for performance of the function performed by the transceiver.

The interface may comprise an interface controller configured to be in communication with a processor, the processor configured to control operation of hardware/software elements to provide the functional expansion provided by the user removable memory.

The user removable memory may comprise one or more antenna elements and the interface is configured to provide the functional expansion by using the one or more antenna elements comprised with the user removable memory.

The interface may be configured to provide an associated electronic device access to one or more software programs to provide the functional expansion. The software program(s) may be stored remotely to the memory e.g. on the device/server to which the memory associates/connects.

The interface may be configured to provide an associated electronic device access to one or more software programs, comprised with the memory, the one or more programs configured to, when run, provide the functional expansion. The software program(s) may comprises one or more special software applications configured for controlling the operation of the particular functional expansion. The software program(s) may comprise one or more special drivers configured to permit an associated electronic device to use the particular functional expansion.

The electronic device may be one or more of a portable electronic device, a hand portable/hand-held electronic device, a PDA, a desktop device, a laptop device, a non-portable electronic device, a television, and a computer.

The apparatus may be a module for a user removable memory or a user removable memory.

In a second aspect, there is provided a method for expanding the functionality provided (to a user) by an electronic device associated with a user removable memory, the method comprising converting signalling between file access signalling for an associated electronic device and appropriate signalling for the use by the memory in providing the functional expansion.

In a third aspect, there is provided a computer program comprising computer code stored in a readable medium, for user removable memory, the memory for providing functional expansion to an associated electronic device, the computer code when executed by a processing component, configured for converting signalling between file access signalling for an associated electronic device and appropriate signalling for the use by the memory in providing the functional expansion.

In a fourth aspect, there is provided a carrier (e.g. memory) comprising the computer program according to the third aspect.

In a fifth aspect, there is provided a means for providing user removable memory to a user operable electronic device, the means for providing user removable memory for the functional expansion of the user operable device, the means for providing user removable memory comprising a means for providing an interface for converting signalling between file access signalling for an associated user operable electronic device and appropriate signalling for the use by the user removable memory in providing the functional expansion.

One or more aspects/embodiments of the present invention as described herein may result in any one or more of the following advantages including providing a solution to the issue of “platform heterogeneity”, while providing ready “plug-and-play” capability.

One or more aspects/embodiments of the present invention may be applicable to electronic portable devices of any technology platform, and include those providing content which may be pre-stored on the SD memory card format, and fetchable from surrounding wireless sensor networks.

The present invention includes one or more aspects, embodiments and/or features of said aspects and/or embodiments in isolation and/or in various combinations whether or not specifically stated (including claimed) in that combination or in isolation.

### BRIEF DESCRIPTION OF DRAWINGS

In order that the present invention may more readily be understood, a description is now given, by way of example only, reference being made to the accompanying drawings in which:—

FIG. 1 is a block schematic drawing of conventional SDIO apparatus:

FIG. 2 is a block schematic drawing of conventional SD storage card apparatus;

FIG. 3 is a block schematic drawing of apparatus of embodiments of the present invention;

FIG. 4 is a view of a hardware module for the apparatus of FIG. 3;

FIG. 5 shows a principle of operation according to an embodiment of the present invention;

FIG. 6 is a representation of the update operation of the apparatus for an embodiment of the present invention;

FIG. 7 is a representation of the program call operation of the apparatus of FIG. 6;

FIG. 8 is a representation of the program call operation of another embodiment of the present invention;

FIG. 9 shows a flowchart according to one embodiment of the invention; and

FIG. 10 comprising FIGS. 10a-10l, illustrates an example of an SD card which provides that the cache/RAM updating is not under the control of the OS of the associated electronic device but as a result of the configuration of the SD card virtualized file.

### DESCRIPTION OF SPECIFIC EMBODIMENTS

For the sake of convenience, the following discussion will focus on SD card memories, but the discussed implementations could be applied other user removable memory.

The SD Input/Output capability (herein after referred to as SDIO) involves the expansion of hardware in a portable device involving the use of a SD card slot.

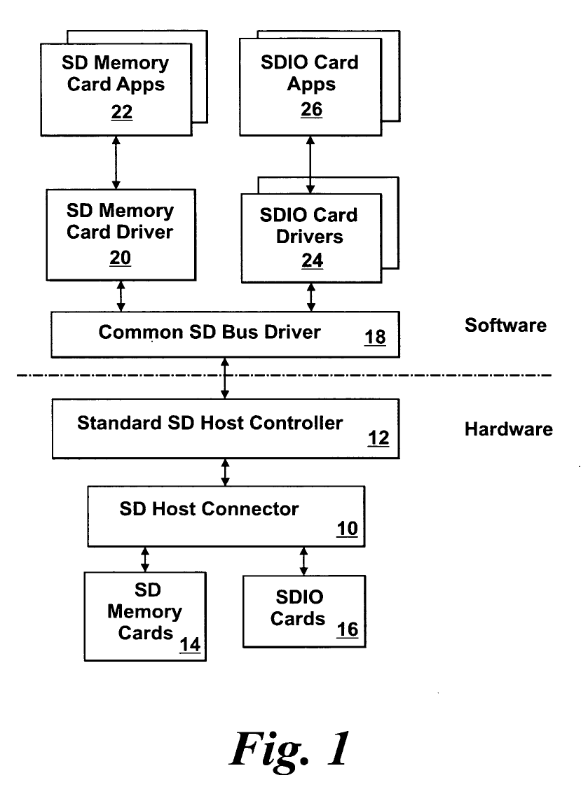

FIG. 1 shows details of the SD Memory card architecture according to the background wherein:—
SD Host Connector 10, is a mechanical card slot;
Standard SD Host Controller 12, is hardware, which (downwards) makes signalling interactions with SD Memory Cards 14 & SDIO Cards 16 through SD Host Connector 10, and (upwards) provides register interface;
Common SD Bus Driver 18, (downwards) performs access to SD Memory Cards 14 & SDIO Cards 16 by operating registers in Standard SD Host Controller 12, and (upwards) provides interfaces for these basic access functions;
SD Memory Card Driver 20, (downwards) performs access to SD Memory Cards 14 by calling Common SD Bus Driver 18, and (upwards) provides function to access files in SD Memory Cards 14 via file system in OS, such that SD Memory Card Applications 22 can realize application layer functions by these file access functions;
SDIO Card Driver 24, performs similar functions to SDIO Cards 16 and provides functions for SDIO Card Applications 26.

The SDIO (SD Input/Output) card is based on and compatible with the SD memory card technical specification. This compatibility includes mechanical, electrical, power, signaling and software. The intent of the SDIO card is to provide high-speed data I/O with low power consumption for mobile electronic devices. A primary goal is that a SDIO card inserted into a non-SDIO aware host causes no physical damage or disruption of that host or its software. Once inserted into an SDIO aware host, the detection of the card proceeds.

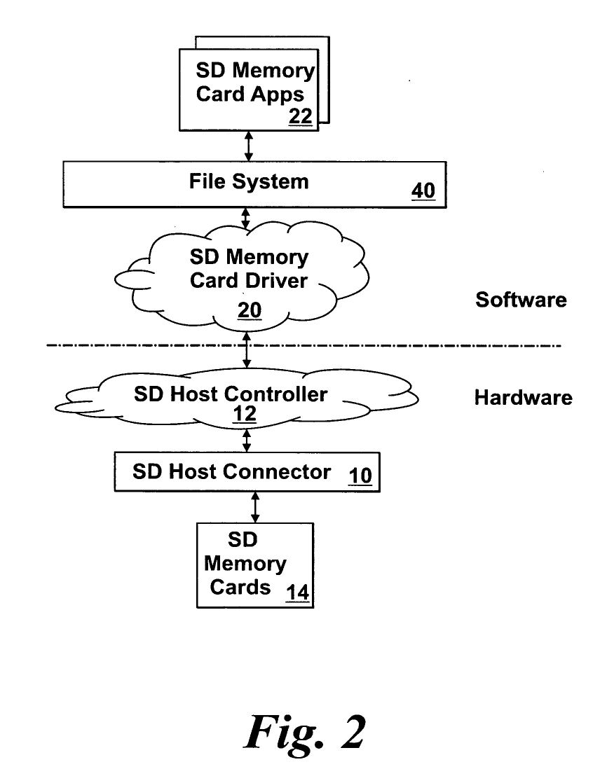

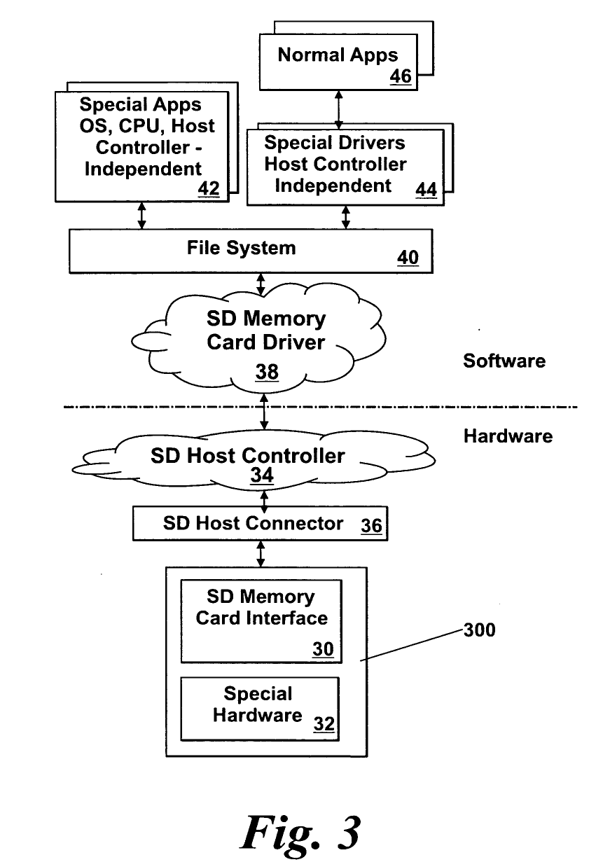

There is shown in FIG. 2 the SD Memory Card architecture in block diagram form.

SD Memory Cards can be recognized as long as an SD slot exists. However, the compatibility of conventional SDIO apparatus is inevitably limited, and particularly is not able to handle platform heterogeneity as different drivers must be provided for the respective various forms of OS, CPUs and host controllers. Accordingly, it is necessary to incorporate additional software and hardware support, including for example a Common SD Bus Driver, SDIO aware host controller, and so on.

FIGS. 3, 4 and 5 show a first implementation of the present invention, which may overcome such difficulties and drawbacks.

Thus, more specifically, an SD Memory Card Interface 30 is provided on an SD memory card 300 in order to transform the SD Memory Card file access command signalling, which had originated from the host 600 (via SD Host Controller 34 and the SD Host Connector 36 and Host Device interface 47), into an appropriate format of signalling which can be used by the Special Hardware 32 to perform the functional expansion providable by the Special Hardware. The SD Memory Cards Interface 30 then returns the results of the operation to the host in the form of file access results/responses.

Given that the host device (electronic device) 600 at least supports the expansion of storage capacity using the SD card format, the modified SD card provides a virtual expansion of the SD memory card without the host device 600 having to use signalling which is only appropriate for the particular expanded functionality provided by the memory card. Read/write commands can be used, at least from the perspective of the electronic device host 600 to control the expanded operation provided by the SD memory card 300.

Implementation in software (that is stored in a readable medium) is by use of SD Memory Card Driver 38, File System 40, Special Applications 42, Special Drivers 44 and Normal Applications 46 as appropriate.

In this way, the expansion Special Hardware 32 is identified as a SD Memory Card, and hence addresses the “platform heterogeneity” issue, and achieves more platform independence capability.

In this embodiment, access to the Special Hardware 32 is limited to the Special Applications 42 alone, and so this embodiment is particularly suitable to application-specific hardware e.g. a digital compass.

All programs (e.g. special applications which are OS&CPU independent, normal applications and special drivers which are OS/CPU dependent) can be saved in the SD storage card, in order to realize the “plug-and-play” capability.

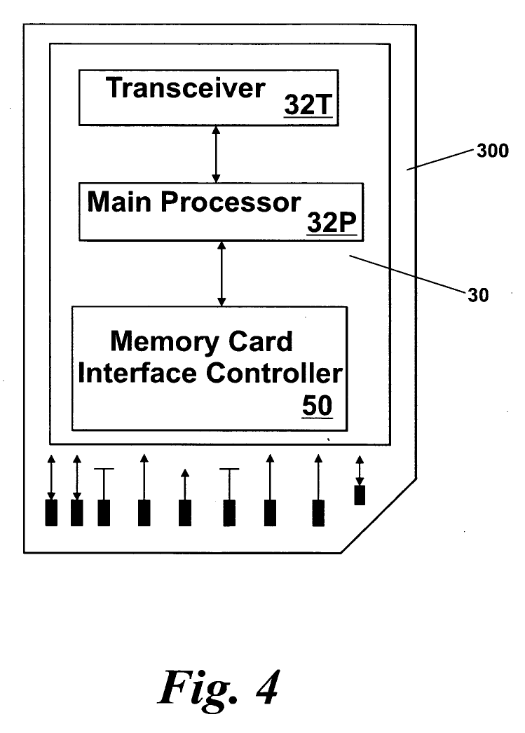

FIG. 4 shows one detailed design of an SD card which can realize the concept of service entry into wireless sensor networks (smart space). The interface 30 comprises elements 50, 32T and 32P. Memory Card Interface Controller 50 is responsible for interaction with host 600. Main Processor 32P is responsible for providing files which can be accessed by the host, and translates file access commands (from the host) into Transceiver operations (and vice versa). Transceiver 32T is responsible for providing access into the wireless sensor network and communications with sensor nodes.

The expansion card 300 is recognized as a standard SD storage card by the host 600, and the host 600 finds there is one web page or Java application stored in the SD card. When opening the web page or Java application, the wireless sensor network related information is displayed, including received packets, network status, etc. Furthermore, the host sends commands and data into the wireless sensor network via the web page or Java application, i.e. query commands, etc. In such a way, a user has wireless sensor network service by the virtual web page or Java application.

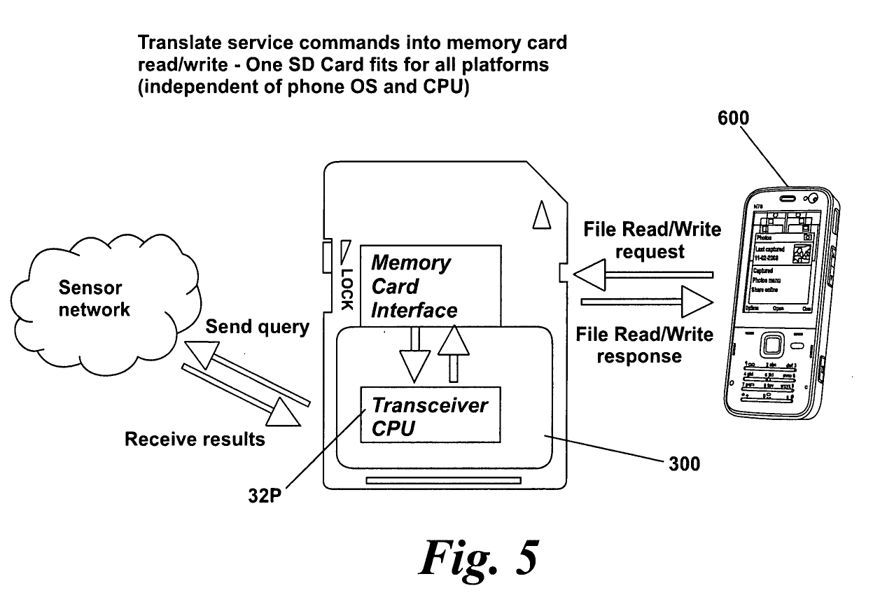

In FIG. 5, the host 600 is shown to send a file read/write request. This is provided to the memory card interface 30, which in turn provides this signalling in a suitable form for controlling the transceiver CPU 32P (FIG. 4/5, in this embodiment, the main processor and the transceiver CPU of FIGS. 4 and 5 perform common functions—in other embodiments, they can be separate and not perform common functions). This results in a query being sent to the wireless sensor network. The result of the query is received from the wireless sensor network by the transceiver CPU 32P, and then provided to the memory interface 30. The memory interface converts this signalling into a file read/write response for the host. From the perspective of the host 600, the signalling is file access signalling (e.g. signalling relating to reading/writing data from a memory, in this case in the SD format).

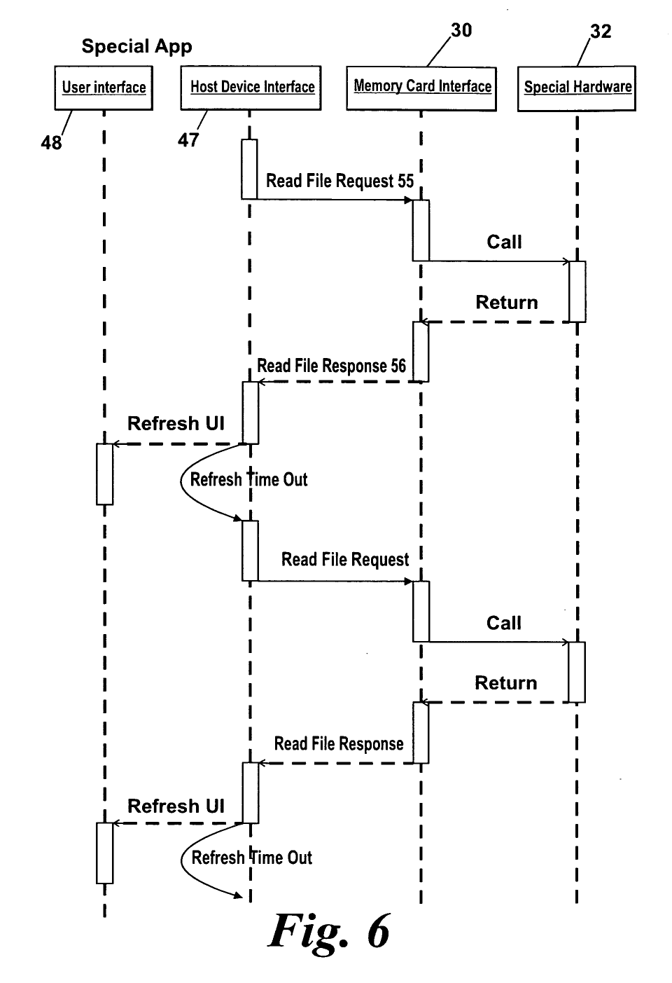

As mentioned above, the smart space access is by operation of the Special Hardware 32 through a web page user interface, FIG. 6 illustrates how the user interface is refreshed.

Host Device Interface 47 (including File System 40 and Driver 44, through which user interface 48 can interact with files stored on SD memory cards) is activated periodically.

Firstly, Read File Request 55 is sent to Memory Card Interface 30 via File System 40; then Memory Card Interface 30 interprets this request to provide a Call to Special Hardware 32. After the Special Hardware 32 completes the required operations, the execution results are returned to Memory Card Interface 30; finally those results are interpreted into web pages by the Memory Card Interface 30, which are further sent (as Read File Response 56) to the Host Device System (via interface 47) and displayed in certain applications (e.g. web browser). In such a way, the user interface of the host 600 is refreshed.

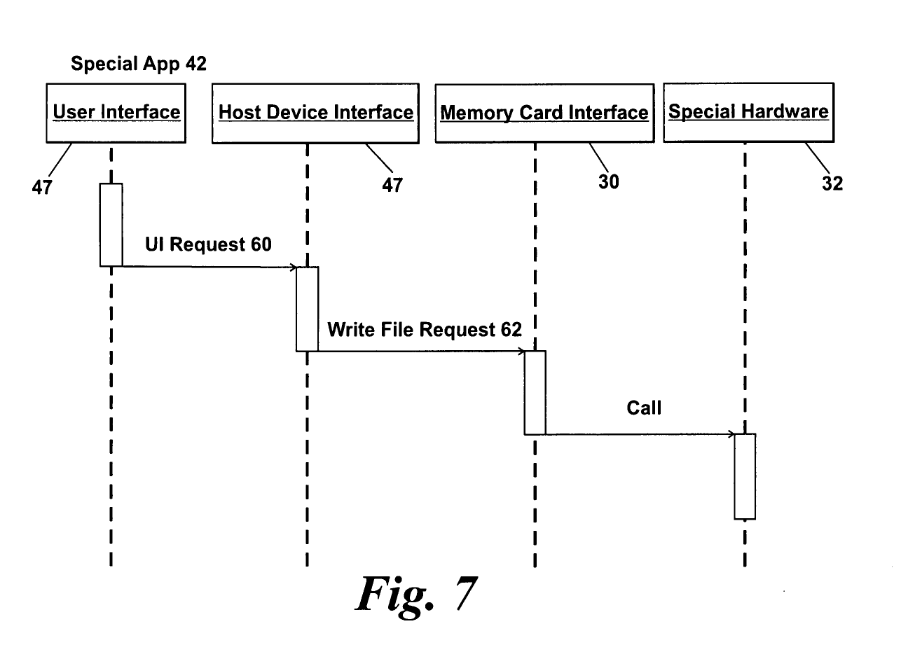

FIG. 7 illustrates the procedure concerning how certain operations are performed. Command input from User Interface 48 is packed into UI Request 60 parameters and sent to Host Device Interface 47, which further interprets them as Write File Request 62 and sends the parameters to Memory Card Interface 30 in the form of one file/document. Finally, Memory Card Interface 30 interprets this Write File Request 62 to provide a Call to Special Hardware 32.

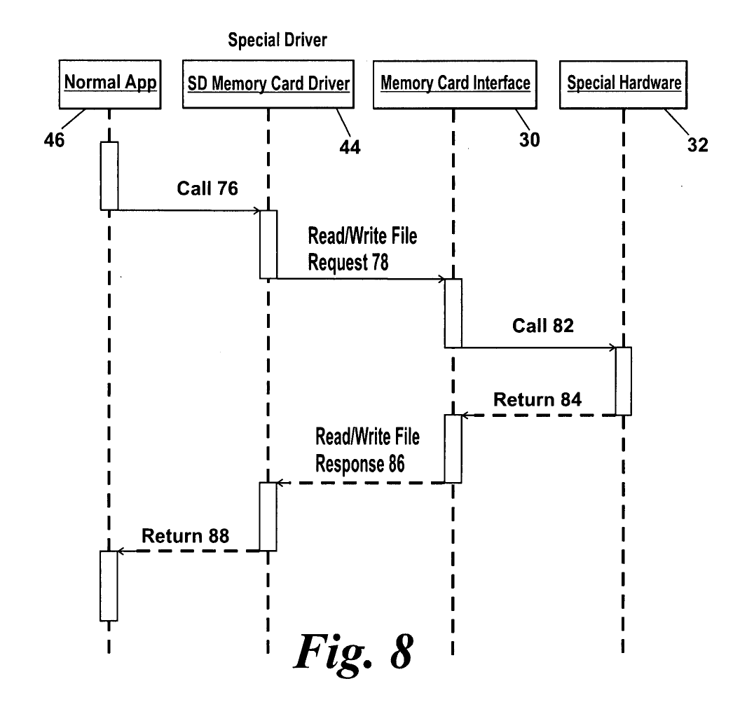

The FIG. 8 embodiment relates to Special Drivers 44 for use with Normal Applications 46. The driver is specially written for the Special Hardware 32. This embodiment is particularly suited for use with hardware for common applications, and may be dependent on the OS facility. Thus it is especially applicable to the general-purpose hardware, e.g. small-size keyboards. All programs can be saved in the SD card to enable “plug-and-play” capability.

The term Normal Applications refers to the normal applications and programs. Thus, taking the example of expanding the functionality to providing camera function, a video chat program can be a Normal App, while the camera driver would be a special driver to run the Normal application. It will be appreciated that a driver acts like a translator between the device and programs that use the device. Each device has its own set of specialized commands that only its driver knows. In contrast, most programs access devices by using generic commands. The driver, therefore, accepts generic commands from a program and then translates them into specialized commands for the device.

Generally speaking, the expansion card 300 is recognized as a standard SD storage card by the host, and there are several drivers stored for different operating systems and CPUs. After a certain special driver 44 is installed according to the OS and CPU of the host, a network access device is recognized by the host 600. Other programs can access wireless sensor networks through this network access device. In such a way, the user can call Normal Applications to have services provided by wireless sensor networks.

More specifically, FIG. 8 illustrates the procedure of Normal Applications 46 accessing Special Hardware 32. Normal Applications 46 Calls a Special Driver 44 with Call 76, and the call is interpreted as a Read/Write File Request 78. Read/Write File Request 78 is sent to Memory Card Interface 30 through File System 40 with call 82. Memory Card Interface 30 interprets this Read/Write Request 78 to provide a Call to Special Hardware 32. The procedure is continued with Return 84, Read/Write File Response 86, Return 88.

A driver may be considered to be divided into two layers—an upper one which provides the common calls to software, and a lower one which controls the hardware. Typically, OS provides a “template” of the upper layer and the driver particularly relates to the lower layer. In this embodiment, the driver may be ported into different OS easily, as file accessing is similar between these OS and open for development (unlike methods to access SD host controllers which are not usually open), the content of the virtualized file for the special hardware 32 being fixed.

Important and distinctive features of each of the embodiments may be that the file content is dynamic and virtual, and changes subject to status of the wireless sensor network. For example, in event-driven wireless sensor networks, when an event happens, the corresponding sensors will report the sensed and processed data to a host that has previously subscribed to the data and is able to interpret the data. In this embodiment, the “data” sent from the wireless sensor network is presented in the form of “file”. One file refers to either data reported by one sensor node or processed data jointly by several sensor nodes. Due to the dynamic and unpredictable nature of wireless sensor network, the file content (e.g. file name, size, etc) is variable.

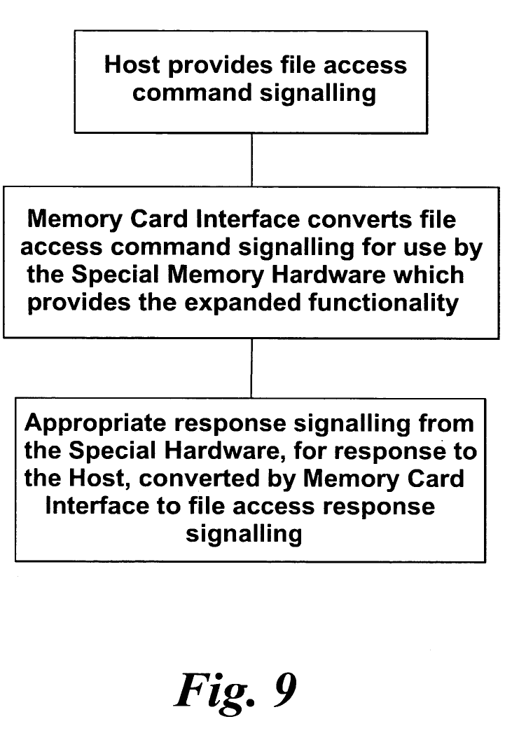

FIG. 9 shows a flowchart which summarises that the communications/signalling with the host are of a file access signalling format.

Cache mechanism is a popular method by which pre-visited content is read from internal-memory/local-host instead of external-memory/remote-host. An example is webpage cache in “Temporary Internet Files” of Microsoft Internet Explorer™, which can make webpage-viewing faster and allow off-line webpage-browsing.

In conventional SD memory cards, any file modification is known to the OS and File System as the data flow CPU<->RAM<->SD memory card is controlled by the OS. However, in the present embodiments, the content (which provides the expanded functionality) provided by the SD card is read from the SD card as a file, bypassing the cache/RAM of the associated electronic device

In certain present embodiments, the content of the ‘virtualized file’ can be modified by external wireless sensor networks. In such cases, there is a problem that if virtualized file content has been changed/updated, and a “cache-hit” event occurs, then the CPU will still fetch the stale/wrong file from cache/RAM. This problem is addressed by using a “cache through mechanism” which forces the CPU to read the virtualized file from the SD card, and not from cache/RAM of the associated electronic device directly.

One way of doing this, which requires modification to host/PDA/associated electronic device is to disable the cache function in host/PDA/associated electronic device. In contrast, the present embodiments, carefully designs the virtualized file address interval & number of virtualized files vs. maximum cache block size & maximum cache block number, in order to artificially make “cache-miss” events happen. This will result in the CPU accessing the memory to get the virtualized files and keep them in the RAM/cache. The cache-miss event can be made to occur if the following two conditions are met:

1. The period (i.e. the number of the files) is larger than maximum cache block number; and
2. The interval (i.e. the address) between the next file and the current file is larger than maximum cache block size.

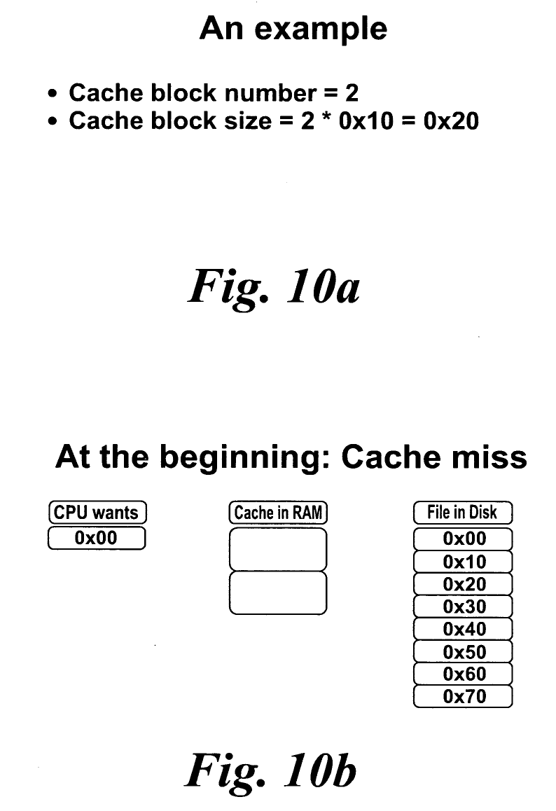

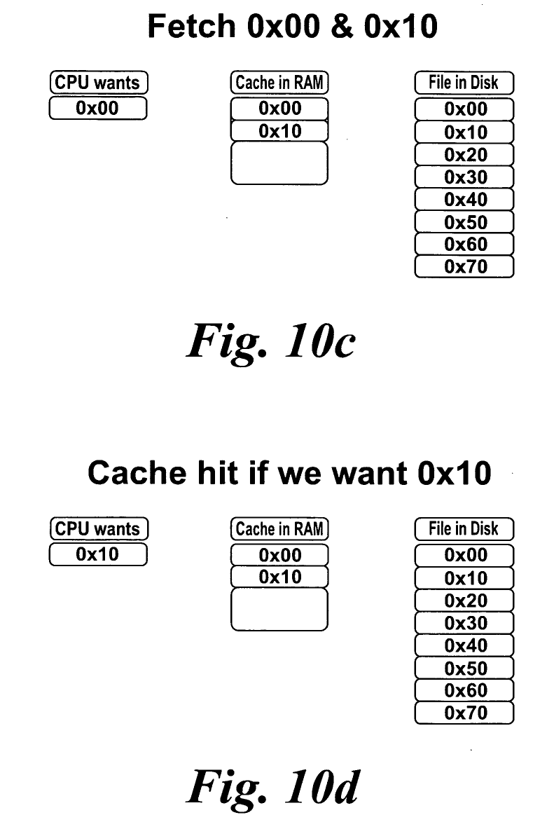

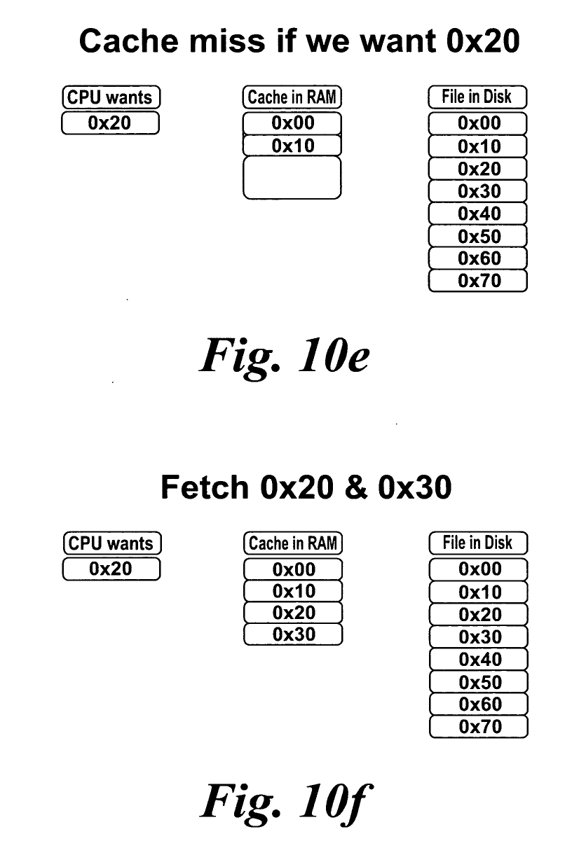

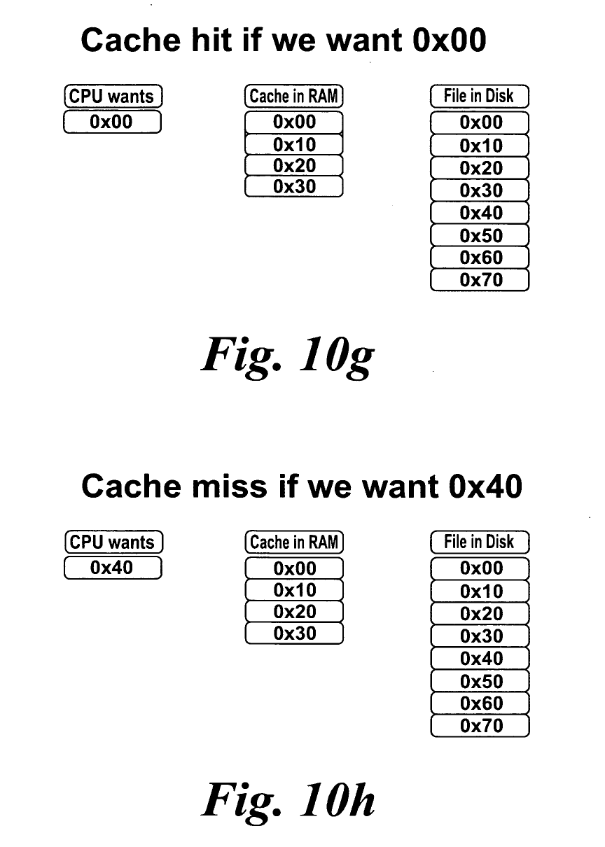

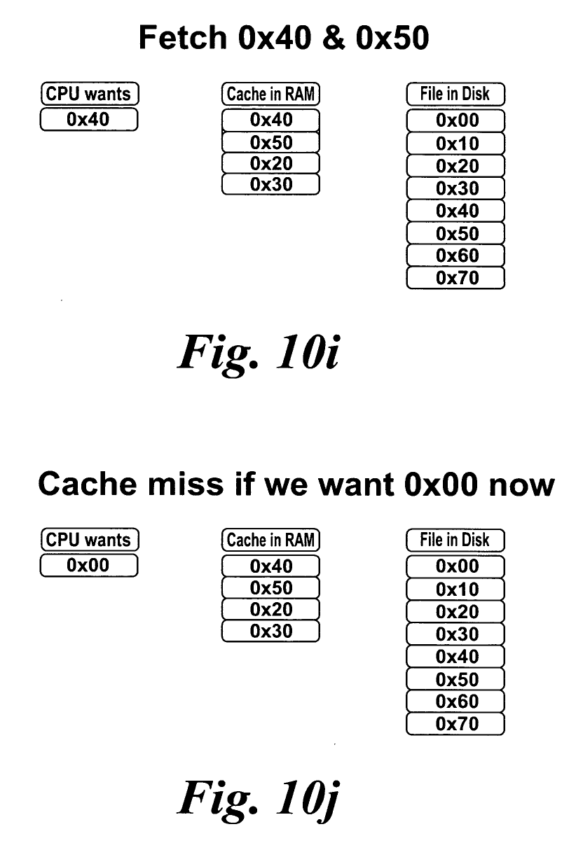

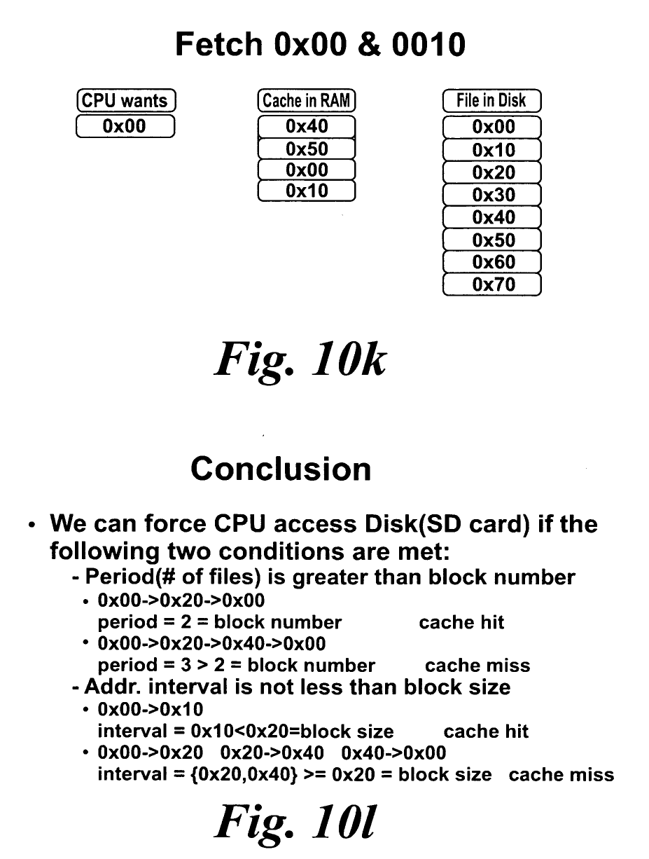

This is because, in periodical file accessing case, the 1st condition prevents the possibility to load all virtualized files into the cache blocks, and the 2nd condition prevents the possibility to simultaneously load two CPU-required virtualized files into the cache blocks. This is shown in FIG. 10 which provides that cache/RAM updating is not under the control of the OS but as a result of the configuration of the SD card virtualized file.

It will be appreciated that certain embodiments translate special wireless transceiver HW manipulation/functionality into file access SW operation via a virtualized SD memory card.

The virtualized files could be either non-user-defined types (e.g. HTML format) or user-defined types.

In the case of non-user-defined type virtualized files, e.g. HTML, the Main Processor (FIG. 432P) translates responses from transceiver 32T into some web pages and translates the web pages operation into requests to the transceiver 32T. For example, if the Wireless Sensor Network (WSN) which the transceiver 32T accesses can sense temperature, the corresponding web pages will contain this information and setting options. The user can read temperature and set the Wireless Sensor Network's parameters so as to control how often the temperature is sensed with the web browser. Usually several virtualized files are provided in order to prevent “cache hit”.

In the case of user-defined type virtualized files, special applications, such as JAVA applications, or special drivers should convert the signals between virtualized files and the special hardware. For example, if the WSN which the transceiver 32T accesses can sense temperature, the corresponding files will contain this information and setting options. The structure of the virtualized file is defined by the special applications or special drivers, so they know how to get the information and set the parameters. The user can read temperature and set the WSN's parameters with the UI provided by the special applications or normal applications. Again, there are usually several virtualized files in order to prevent “cache hit”.

As a practical example, consider an electronic device which has a standard SD memory card read/write slot, but does not have WLAN capability. When an appropriately modified SD card (with WLAN hardware functionality) is inserted into the SD slot, the SD card is read by the electronic device as providing a link to a website providing local weather content. This link is provided by the WLAN hardware of the SD card but the electronic device only considers to it be provided by a read operation of the inserted SD card. Then, when another different SD card is provided, a different link can be provided e.g. to local traffic update using the WLAN functionality of that SD card. Furthermore, when a further different SD card is provided (one with GPS hardware), GPS content may be provided via the GPS hardware of the SD card to the device as a read response command.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description, it will be evident to a person skilled in the art that various modifications may be made within the scope of the invention. One or more of the previously described elements/circuitry may have additional functions to those described i.e. they may be configured to perform other additional functions beyond those described.

While there have been shown and described and pointed out fundamental novel features of the invention as applied to preferred embodiments thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto. Furthermore, in the claims means-plus-function clauses are intended to cover the structures described herein as performing the recited function and not only structural equivalents, but also equivalent structures. Thus although a nail and a screw may not be structural equivalents in that a nail employs a cylindrical surface to secure wooden parts together, whereas a screw employs a helical surface, in the environment of fastening wooden parts, a nail and a screw may be equivalent structures.

What is claimed is:

1. An apparatus for user removable memory, the memory for providing functional expansion to an associated electronic device, the apparatus comprising an interface configured for converting signalling between file access signalling for an associated electronic device and appropriate signalling for the use by the memory in providing the functional expansion.

2. The apparatus according to claim 1, wherein the interface is configured to convert signalling from within the apparatus, the signalling for the provision of the functional expansion to an associated electronic device, into file access response signalling for an associated electronic device.

3. The apparatus according to claim 1, wherein the interface is configured to convert signalling from an associated electronic device from file access command signalling into appropriate signalling, for use within the memory, to provide the functional expansion using the memory.

4. The apparatus according to claim 1, wherein the interface is configured to, in response to file access command signalling from an associated electronic device, convert the file access command signalling into appropriate signalling, for use within the memory, for the provision of the functional expansion using the memory by using file access response signalling.

5. The apparatus according to claim 1, wherein the interface is configured to, in response to file access command signalling from an associated electronic device, convert the file access command signalling into appropriate signalling, for use within the memory, for the provision of the functional expansion using the memory and provide, in response to the file access command signalling, file access response signalling from the apparatus to an associated electronic device to provide the functional expansion.

6. The apparatus according to claim 1, wherein the file access signalling comprises one or more of read/write request/response signalling.

7. The apparatus according to claim 1, wherein the apparatus is configured to force updating of a cache of the associated electronic device with virtualized file(s), the virtualized file(s) for providing for the functional expansion of the associated electronic device, by creating cache-miss events.

8. The apparatus according to claim 1, wherein the user removable memory conforms to one or more of a secure digital format, a multimedia card format, compact flash format, and a personal computer memory card international association format.

9. The apparatus according to claim 1, wherein the functional expansion comprises the provision of wireless functionality.

10. The apparatus according to claim 9, wherein the wireless functionality comprises one or more of wireless local area network functionality, Zigbee™ functionality, Wibree™ functionality, Bluetooth™ functionality, global positioning system functionality, digital TV receiver functionality, audio functionality and video functionality.

11. The apparatus according to claim 9, wherein the wireless functionality provides for connection of an associated electronic device with a user interface apparatus.

12. The apparatus according to claim 1, wherein the functional expansion comprises the provision of functionality not already integrated with or available to an associated electronic device.

13. The apparatus according to claim 1, wherein the apparatus comprises a transceiver for providing the functional expansion, and the interface is configured to convert read/write signalling requests from an associated electronic device into signalling appropriate for performance of the function performed by the transceiver.

14. The apparatus according to claim 1, wherein the interface comprises an interface controller configured to be in communication with a processor, the processor configured to control operation of hardware/software elements to provide the functional expansion provided by the user removable memory.

15. The apparatus according to claim 1, wherein the user removable memory comprises one or more antenna elements and the interface is configured to provide the functional expansion by using the one or more antenna elements comprised with the user removable memory.

16. The apparatus according to claim 1, wherein the interface is configured to provide an associated electronic device access to one or more software programs, comprised with the memory, the one or more programs configured to, when run, provide the functional expansion.

17. The apparatus according to claim 16, wherein the software program(s) comprises one or more special software applications configured for controlling the operation of the particular functional expansion.

18. The apparatus according to claim 16, wherein the software program(s) comprises one or more special drivers configured to permit an associated electronic device to use the particular functional expansion.

19. The apparatus according to claim 1, wherein the electronic device is one or more of a portable electronic device, a hand portable/hand-held electronic device, a PDA, a desktop device, a laptop device, a non-portable electronic device, a television, and a computer.

20. The apparatus according to claim 1, wherein the apparatus is a module for a user removable memory or a user removable memory.

21. A method for expanding the functionality provided by an electronic device associated with a user removable memory, the method comprising converting signalling between file access signalling for an associated electronic device and appropriate signalling for the use by the memory in providing the functional expansion.

22. A readable medium stored with computer code for user removable memory, the memory for providing functional expansion to an associated electronic device, the computer code when executed by a processor for converting signalling between file access signalling for an associated electronic device and appropriate signalling for the use by the memory in providing the functional expansion.

23. An apparatus comprising means for providing user removable memory to a user operable electronic device, the means for providing user removable memory for the functional expansion of the user operable device, the means for providing user removable memory further comprising means for providing an interface for converting signalling between file access signalling for an associated user operable electronic device and for providing appropriate signalling for the use by the user removable memory in providing the functional expansion.
